(19) United States
(12) Patent Application Publication
(10) Pub. No.: US 2008/0184588 A1
(43) Pub. Date: Aug. 7, 2008

(54) AUTO COIN

(75) Inventors: Soren Juul Somod, Svendborg (DK); Gary Brown, West Babylon, NY (US)

Correspondence Address: PEARNE & GORDON LLP, 1801 EAST 9TH STREET, SUITE 1200, CLEVELAND, OH, 44114-3108, US

(73) Assignee: AKTIEBOLAGET ELECTROLUX

(21) Appl. No.: 11/426,589

(22) Filed: Jun. 27, 2006

(51) Int. Cl. F26B 21/10; F26B 3/04; F26B 19/00; F26B 25/22; F26B 23/04; F26B 23/10

(52) U.S. Cl. 34/495; 34/553; 34/554; 34/549

(57) ABSTRACT

A coin-operated dryer includes a tumbler and heating means for providing heated air to the tumbler. One or more sensors are coupled to the dryer and to a controller, which is configured to receive information from the sensor(s). The controller uses the information received from the at least one sensor to control the heating means. Thus, the heating means can be turned off or reduced prior to expiration of a paid for drying time, thereby mitigating energy waste.

### BACKGROUND OF THE INVENTION

1) Field of the Invention

The present invention relates generally to clothes dryers. In particular, the present invention relates to energy saving systems and methods for coin-operated clothes dryers.

2) Description of the Related Art

Clothes dryers are one of the most expensive appliances to operate. The longer the dryer runs, the more money it costs to the operator. Thus, when the dryer runs longer than necessary, there is significant energy waste. This is of importance in view of increasing environmental concerns and rising energy costs. In coin-operated dryers, a user pays for a predetermined drying time. Typically, the user runs the dryer with a reduced load but pays for more than a full load to ensure drying of the clothing load in the dryer. Accordingly, there is a need for a system that minimizes dryer operating costs and energy waste in coin-operated dryers.

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a coin-operated dryer is provided. The coin-operated dryer includes a tumbler and heating means for providing heated air to the tumbler. One or more sensors are coupled to the dryer and to a controller, which is configured to receive information from the sensor(s). The controller uses the information received from the at least one sensor to control the heating means. Thus, the heating means can be turned off or reduced prior to expiration of a paid for drying time, thereby mitigating energy waste.

In accordance with another aspect of the present invention, a method of operation for a coin-operated drying is provided. The method includes: drying a clothing load until at least one sensor determines that the clothing load is sufficiently dry; switching to a cool down temperature when the at least one sensor determines that the clothing load is sufficiently dry; and continuing operating at the cool down temperature until a paid for time period expires.

In accordance with yet another aspect of the present invention, a coin-operated dryer is provided. The coin-operated dryer includes: means for heating air provided to a tumbler; means for sensing drying of a clothing load; and means for controlling operation of the means for heating. The means for controlling switches the means for heating to a cool down temperature when the means for sensing senses that the clothing load is dry. The coin-operated dryer runs until a paid for time expires.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings.

FIG. 1 illustrates a schematic of a coin-operated dryer in accordance with an aspect of the present invention.

FIG. 2 illustrates a graphical representation of an example operation of a coin-operated clothes dryer in accordance with an aspect of the present invention.

FIG. 3 illustrates a schematic block diagram of a control system for a coin-operated clothes dryer in accordance with an aspect of the present invention.

FIG. 4 illustrates a chart showing examples of energy savings that can be achieved in accordance with an aspect of the present invention.

### DESCRIPTION OF EXAMPLE EMBODIMENTS

The present invention relates to a coin-operated clothes dryer. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

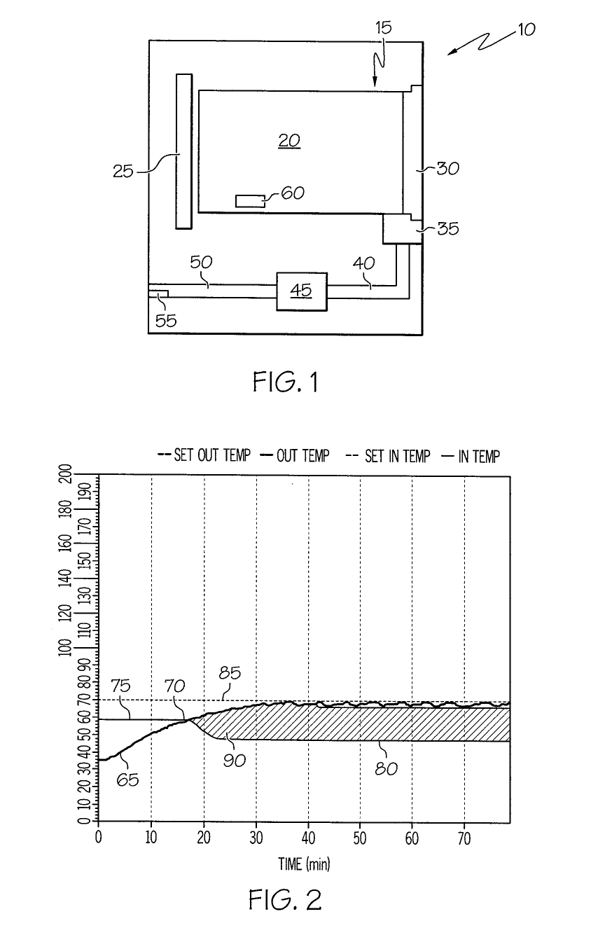

Referring initially to FIG. 1, a block diagram of a typical clothes dryer 10, including a coin operated clothes dryer, is illustrated in accordance with an aspect of the present invention. The dryer 10 includes a dryer chamber 15 having a rotatable tumbler 20 for tumbling a clothing load. In an electric dryer, a heating element 25 is provided near the tumbler 20 for heating air that enters the dryer 10. The air heated by the heating element 25 enters the tumbler 20 to facilitate drying of the clothing load. Although the heating element 25 is shown in FIG. 1 as being positioned to a rear portion of the tumbler 20, it is to be appreciated that one or more heating elements can be provided in any suitable location in the dryer to provide heated air to the tumbler 20. In a gas dryer, heated air passes through a gas jet (not shown) into the tumbler 20 to facilitate drying of the clothing load. The tumbler 20 includes holes (not shown) through a surface of the tumbler 20 for receiving the heated air. For instance, in the present example, since the heating element 25, or gas jet, is positioned to the rear of the tumbler 20, the tumbler 20 would include holes in a rear wall thereof to receive the heated air. The air from the tumbler 20 flows through the holes provided in an outer diameter of the tumbler 20 and into a lint filter 35 positioned near a bottom portion of the tumbler 20. The air is then drawn through the lint filter 35 and through a first duct 40 where it enters a fan 45. The fan 45 forces the heated air out a second duct 50 at a back or top portion of the dryer 10.

In a coin-operated dryer, the above-described process is continuously operated until a paid for time runs out. Thus, it is possible and likely that the clothing load is sufficiently dried prior to the running out of the paid for time. Operating the heating element 25 or gas jet after the clothes have dried wastes energy and thus, money, and can potentially damage items in the clothing load. Accordingly, the present invention provides a system and method for sensing the dryness of the clothing load. Once one or more sensors have determined that the clothing load is sufficiently dried, the heating element or gas jet is turned off or substantially decreased to place the dryer into a low temperature drying mode.

In accordance with one example of the present invention, at least one temperature sensor 55 is positioned in or near the exhaust duct 50. The temperature sensor(s) 55 provides an accurate measurement of the drying temperature for the air in tumbler 20. Alternatively, one or more resistance sensors 60 can be positioned in the tumbler 20 for sensing moisture in the surface of the fabrics within the tumbler 20. When the surface of the fabrics are sufficiently dry, the resistance of the outer surface, as measured by the sensor(s) 60, changes in an amount sufficient to indicate dryness.

Turning now to FIG. 2, a graphical representation of an example operation of the coin-operated clothes dryer is illustrated in accordance with an aspect of the present invention. Once the dryer is activated, the dryer operates normally until a sensor that senses an outlet temperature, which is indicated by line 65, indicates that the clothing load in the dryer is dry. When employing a temperature sensor at an outlet, this point is reached when the outlet temperature reaches an inlet temperature, or in other words at the intersection 70 between line 65 and line 75 (the inlet temperature). Once this point is reached, the dryer heat (e.g., the heating element or the gas jet) is turned off or substantially decreased and the dryer operates at a predetermined cool down temperature until the paid for time runs out on the dryer. The cool down temperature is indicated by line 80 after intersection point 70. In conventional systems, the dryer operates such that the outlet temperature ramps up to a maximum outlet temperature, indicated by line 85, and remains at the maximum outlet temperature until the paid for time runs out on the dryer. In contrast, the outlet temperature for the dryer of the present invention only ramps up to the point where the clothing load in the dryer is dry and then drops to a lower predetermined temperature until time runs out on the dryer. Accordingly, the present invention facilitates significant energy savings, as illustrated by shaded area 90.

As mentioned above, one method that can be employed to determine when the clothing load in the dryer is dry is to measure the air temperature at the outlet of the exhaust duct. The dryer can include a first temperature sensor at a hot air inlet of the tumbler and a second temperature sensor in an outlet duct of the dryer. The first and second temperature sensors are operable to produce temperature signals indicative of the inlet air temperature and tumbler outlet temperature, respectively. A controller monitors the inlet and outlet temperatures from the first and second temperature sensors. When the outlet temperature is substantially equal to the inlet temperature, the heating means of the dryer is turned off or significantly reduced. Alternatively, the dryer can include only a temperature sensor in an outlet duct of the dryer. When the outlet temperature reaches a predetermined temperature, the heating means of the dryer is turned off or significantly lowered.

Another method that can be utilized to determine when a clothing load in the dryer is dry is to measure the actual moisture content of the clothing load. Thus, the heating process can be stopped or decreased at a desired residual moisture content. The dryer includes a plurality of electrical contact electrodes on an internal surface of the tumbler. The electrodes are intermittently bridged by the articles in the clothing load as they are tumbled. By measuring the electrical resistance between the electrodes and through the articles, the moisture content of the clothing load can be determined. The moisture content is proportional to the conductivity. A voltage is applied via a resistor to the electrodes, and causes current to flow through the articles. A voltage drop across the textile goods is measured at the electrodes. This voltage drop is used to determine the conductivity, and the moisture content, of the textile goods. When the clothing load is sufficiently dry, a controller operates to turn off the heating means or significantly lower the heat produced by the heating means.

Additionally or alternatively, the coin operated clothes dryer can include a humidity sensor for sensing an amount of moisture left in the dryer. For instance, the humidity sensor can be provided at lint filter of the dryer to determine the amount of humidity in the air flowing through the lint filter. When the humidity decreases to about zero humidity, the sensor signals that the garment(s) in the dryer is dry and the heat in the dryer is decreased to a predetermined cool down temperature, which could be zero heat.

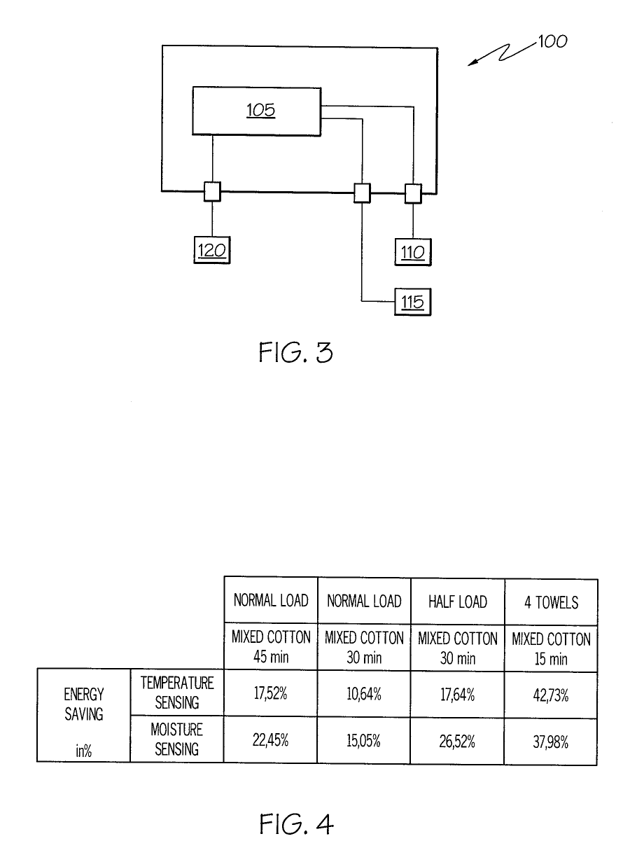

Turning now to FIG. 3, a schematic block diagram of a control system 100 for a coin-operated clothes dryer is shown in accordance with an aspect of the present invention. The control system 100 includes a controller 105, which is in communication with one or more sensors 110, 115. The controller 105 is also in communication with heating means 120 for the dryer. The heating means 120 can be a heating element in an electric dryer or a gas element in a gas dryer. The term controller is not limited to just those integrated circuits referred to in the art as controllers, but broadly refers to microprocessors, computers, processors, microcontrollers, microcomputers, programmable logic controllers, application specific integrated circuits, field programmable gate arrays, and other programmable circuits. Additionally, although specific sensors (i.e., temperature, resistance, humidity) are described herein, it is to be appreciated that any other suitable sensor or combination of suitable sensors can be employed with the present invention to indicate a dryness level of the clothing load in the tumbler. Once a suitable dryness level is achieved, the sensor(s) 110, 115 sends a signal to a controller 105, which decreases the heating means 120 of the dryer to a predetermined cool down temperature.

FIG. 4 illustrates a chart showing examples of energy savings that can be achieved in accordance with an aspect of the present invention. The energy savings have been found to be between 10-40% and varies depending on filling rate, type of garment, and the paid time. When measuring resistance: the energy savings for a normal mixed cotton load when 45 minutes is paid for is about 22%; the energy savings for a normal mixed cotton load when 30 minutes is paid for is about 15%; the energy savings for a half load of mixed cotton articles when 30 minutes is paid for is about 27%; and the energy savings for a mixed cotton load of four towels is about 38%. When measuring an outlet temperature of the dryer: the energy savings for a normal mixed cotton load when 45 minutes is paid for is about 18%; the energy saving for a normal mixed cotton load when 30 minutes is paid for is about 11%; the energy savings for a half load of mixed cotton articles when 30 minutes is paid for is about 18%; and the energy savings for a mixed cotton load of four towels is about 43%. Measuring resistance appears to be most effective when detecting when the lower the heating means, however measuring the outlet temperature appears to be the least expensive and most reliable system.

It is also noted that if the clothing load is very small and includes very thick articles, such as having only a couple pairs of jeans, the operation of the dryer can be bypassed by a special function developed to detect such loads. For instance, if such a load is detected and the sensor(s) determines that the clothing load is dry and a predetermined time or less than a predetermined time (e.g., two minutes) is left, the dryer will continue to operate at full heat rather than enter a low temperature mode.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible.

What is claimed is:

1. A coin-operated dryer comprising:
a tumbler;
heating means for providing heated air to the tumbler;
at least one sensor; and
a controller configured to receive information from the at least one sensor,
wherein the controller uses the information received from the at least one sensor to control the heating means.

2. The coin-operated dryer of claim 1, wherein the controller can prompt the dryer to enter a cool down mode prior to expiration of a paid for time.

3. The coin-operated dryer of claim 1, wherein the heating means is an electrical heating element.

4. The coin-operated dryer of claim 1, wherein the heating means is a gas jet.

5. The coin-operated dryer of claim 1, wherein the at least one sensor includes a sensor positioned in an outlet duct of the dryer.

6. The coin-operated dryer of claim 5, wherein the at least one sensor further includes a sensor positioned near an air inlet of the tumbler.

7. The coin-operated dryer of claim 1, wherein the at least one sensor includes a resistance sensor positioned in the tumbler.

8. A method of operation for a coin-operated drying comprising:
drying a clothing load until at least one sensor determines that the clothing load is sufficiently dry;
switching to a cool down temperature when the at least one sensor determines that the clothing load is sufficiently dry; and
continuing operating at the cool down temperature until a paid for time period expires.

9. The method of claim 8, wherein determining that the clothing load is sufficiently dry is achieved by sensing a temperature in an outlet duct of the dryer.

10. The method of claim 9, wherein determining that a clothing load is sufficiently dry is achieved by sensing a temperature proximate an air inlet of a tumbler and comparing the temperature in the outlet duct with the temperature proximate the air inlet of the tumbler.

11. The method of claim 8, wherein determining that the clothing load is sufficiently dry is achieved by sensing a resistance in the clothing load.

12. The method of claim 8 further comprising, overriding the step of switching to a cool down temperature if a small load is detected and there is less than a predetermined time left in the drying process.

13. A coin-operated dryer comprising:
means for heating air provided to a tumbler;
means for sensing drying of a clothing load; and
means for controlling operation of the means for heating,
wherein the means for controlling switches the means for heating to a cool down temperature when the means for sensing senses that the clothing load is dry, and
wherein the coin-operated dryer runs until a paid for time expires.

14. The coin-operated dryer of claim 13, wherein the means for heating includes an electrical heating element.

15. The coin-operated dryer of claim 13, wherein the means for heating includes a gas heater.

16. The coin-operated dryer of claim 13, wherein the means for sensing includes at least one temperature sensor.

17. The coin-operated dryer of claim 13, wherein the means for sensing includes at least one resistance sensor.
